(19) United States
(12) Patent Application Publication
(10) Pub. No.: US 2026/0261209 A1
(43) Pub. Date: Sep. 3, 2026

(54) SYSTEMS AND METHODS FOR DC-DC CONVERSION

(71) Applicants: Toyota Motor Engineering & Manufacturing North America, Inc., Plano, TX (US); The Regents of the University of Colorado, Boulder, CO (US)

(72) Inventors: Sayan Paul, Boulder, CO (US); Ashwini Kumar Dubey, Boulder, CO (US); Dragan Maksimovic, Boulder, CO (US); Yamato Iwasaki, Shizuoka-ken (JP); Nobuaki Satoh, Shizuoka-ken (JP); Yanghe Liu, Ann Arbor, MI (US); Shailesh Joshi, Ann Arbor, MI (US)

(73) Assignees: Toyota Motor Engineering & Manufacturing North America, Inc., Plano, TX (US); Toyota Jidosha Kabushiki Kaisha, Aichi-ken (JP); The Regents of The University of Colorado, Boulder, CO (US)

(21) Appl. No.: 19/067,110

(22) Filed: Feb. 28, 2025

(51) Int. Cl. H02M 3/335; H02M 1/00; H02M 3/00

(52) U.S. Cl. CPC H02M 3/33576; H02M 1/0048; H02M 3/01

(57) ABSTRACT

A converter system disclosed herein includes a boost converter module including one or more boost switches, a dual-active bridge (DAB) converter module including one or more DAB switches, and one or more processors. The boost converter module is electrically coupled to the DAB converter module in an input parallel and output series (IPOS) configuration. The one or more processors operable to determine one or more time parameters to cause the boost converter module and the DAB converter module to operate at determined operation conditions in an operating range to control an energy loss.

### TECHNICAL FIELD

The present disclosure relates to systems and methods for direct current (DC) power to DC power conversion.

### BACKGROUND

In the application of electricity, often modern electronic systems may suffer power systems fluctuating input voltage, varying load conditions, space constraints, noise sensitivity, and undesired power loss during operation. Accordingly, a need exists for a DC-DC system with advanced DC-DC converters to operate under a desired voltage operation with improved voltage or current regulation and controlled conversion efficiency.

### SUMMARY

In one embodiment, a converter system includes a boost converter module including one or more boost switches, a dual-active bridge (DAB) converter module including one or more DAB switches, and one or more processors. The boost converter module is electrically coupled to the DAB converter module in an input parallel and output series (IPOS) configuration. The one or more processors are operable to determine one or more time parameters to cause the boost converter module and the DAB converter module to operate at determined operation conditions in an operating range to control an energy loss.

In another embodiment, a method for controlling energy loss of a converter system includes providing the converter system including a boost converter module including one or more boost switches and a boost inductor, and a dual-active bridge (DAB) converter module including one or more DAB switches, a DAB inductor, and a transformer, the DAB converter module configured to be electrically coupled to the boost converter module in an input parallel and output series (IPOS) configuration, determining a design-time parameter based on an inductance of the DAB inductor, an inductance of the boost inductor, a transformation ratio of the transformer, or a combination thereof, determining one or more run-time parameters for one or more operating points in an operating range such that a converter system energy loss at any operation point is less than or equal to a worst-case energy loss, and operating the converter system based on the design-time parameter and the one or more run-time parameters.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system of composite DC-DC converters of the present disclosure, according to one or more embodiments shown and described herewith;

FIG. 2 schematically depicts example components of a controller for the composite DC-DC converters of the present disclosure, according to one or more embodiments shown and described herein;

FIG. 3A schematically depicts an example first DC-DC converter of the present disclosure, according to one or more embodiments shown and described herein;

FIG. 3B schematically depicts an example second DC-DC converter of the present disclosure, according to one or more embodiments shown and described herein;

FIG. 4A depicts an illustrative block diagram for determining energy loss for the second DC-DC converter of the present disclosure, according to one or more embodiments shown and described herein;

FIG. 4B depicts a current waveform of the second DC-DC converter of the present disclosure, according to one or more embodiments shown and described herein;

FIG. 5A depicts an illustrative block diagram for determining energy loss for the first DC-DC converter of the present disclosure, according to one or more embodiments shown and described herein;

FIG. 5B depicts a current waveform of the first DC-DC converter of the present disclosure, according to one or more embodiments shown and described herein;

FIG. 6 depicts an illustrative block diagram for determination of design-time parameter and run-time parameter for energy loss control of the present disclosure, according to one or more embodiments shown and described herein;

FIG. 7A depicts example optimal voltages sharing between the first DC-DC converter and the second DC-DC converter of the present disclosure, according to one or more embodiments shown and described herein;

FIG. 7B depicts an example second DC-DC converter waveforms for operating point b in FIG. 7A of the present disclosure, according to one or more embodiments shown and described herein;

FIG. 7C depicts an example first DC-DC converter waveforms for operating point b in FIG. 7A of the present disclosure, according to one or more embodiments shown and described herein;

FIG. 7D depicts an example second DC-DC converter waveforms for operating point c in FIG. 7A of the present disclosure, according to one or more embodiments shown and described herein;

FIG. 7E depicts an example first DC-DC converter waveforms for operating point c in FIG. 7A of the present disclosure, according to one or more embodiments shown and described herein;

FIG. 7F depicts an example first DC-DC converter waveforms for operating point e in FIG. 7A of the present disclosure, according to one or more embodiments shown and described herein; and

FIG. 8 depicts a flowchart for operating an example composite DC-DC converter system of the present disclosure, according to one or more embodiments shown and described herein.

### DETAILED DESCRIPTION

Operating power converters in a controllable manner throughout their operating range is desired for wide-range applications, such as, without limitation, direct current (DC)-DC conversion in hybrid and electric vehicles. In hybrid (HEV), plug-in hybrid (PHEV), and electric vehicles (EV), the need for highly-efficient, compact on-board DC-DC converters with wide input and output voltage ranges arises in different application scenarios. For example, one scenario can be interfacing relatively small, typically lower-voltage (e.g., 200-400 V) HEV/PHEV battery packs to a higher-voltage (e.g., 800 V) DC bus for powertrain electric drives. Another scenario can be ensuring compatibility of emerging 800 V xEV battery packs with already installed fast DC chargers, which are predominantly tailored to 400 V battery packs. Existing approaches to on-board DC-DC converters include various interleaved, multi-level, and soft-switched topologies, and composite converters, where combinations of multiple dissimilar partial-power modules are used to reduce component stresses and the size of magnetics, leading to efficiency and power density improvements. However, these approaches do not address the issue arising due to multiple converter modules in composite converters, such as energy loss during the electric energy conversion.

This disclosure presents embodiments encompassing systems and methods to control and minimize the energy loss in DC-DC converter composite systems, for example, in a multiple-module composite converter architecture including a boost converter, a dual-active bridge (DAB) converter, a step-down converter (e.g., a buck converter), or a combination thereof, in a composite connection configuration, such as, an input-parallel output-series (IPOS) configuration, or an input-series output-parallel (ISOP) configuration.

Throughout the disclosure, “electrically coupling” or “electrically coupled” refers to a physical or functional connection between two or more components or circuits such that electrical signals or power can flow between them. The electrical coupling may involve direct or indirect connections, using conductors, wires, traces, or other conductive materials, to allow the transfer of electrical energy, signals, or information. The electrical coupling can be achieved through various methods, such as, without limitations, direct wiring, connectors, or through components like capacitors, resistors, or inductors, which allow for the transmission of electrical current or voltage in the system.

As used herein, the singular forms “a,” “an” and “the” include plural referents unless the context clearly dictates otherwise. Thus, for example, reference to “a” component includes aspects having two or more such components unless the context clearly indicates otherwise.

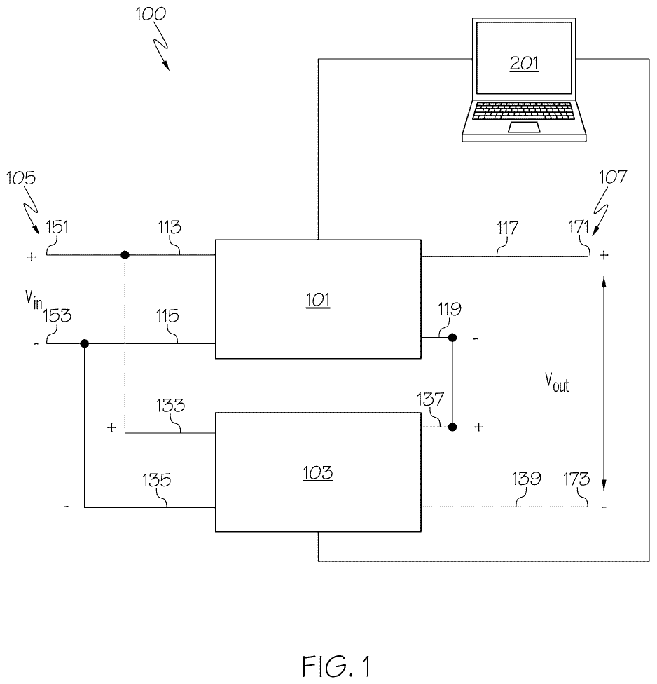

Referring now to figures, FIG. 1 schematically depicts an example composite DC-DC converter system 100. In embodiments, the composite DC-DC converter system 100 includes two or more converter modules, such as a first DC-DC converter 101, a second DC-DC converter 103, and/or a buck converter. The composite DC-DC converter system 100 is electrically coupled to a DC electric source, with an input voltage (Vᵢₙ) and is electrically coupled to a load, with an output voltage (Vₒᵤₜ). In embodiments, the composite DC-DC converter system 100 includes a converter input port 105 electrically coupled to the DC electric source and a converter output port 107 electrically coupled to the load. The converters may be electrically connected to each other in predetermined configurations, such as, without limitations, the IPOS configuration, and the ISOP configuration. In embodiments, the composite DC-DC converter system 100 may include, without limitation, a boost converter and a DAB converter in the IPOS configuration, a non-inverting buck-boost converter and a DAB converter in the IPOS configuration, a non-inverting buck-boost converter and a DAB converter in the ISOP configuration, a buck converter and a DAB converter in the ISOP configuration.

In embodiments, the composite DC-DC converter system 100 includes a controller 201 that receives and/or determines operation parameters of the composite DC-DC converter system 100, and further causes the converters, such as, the first DC-DC converter 101, the second DC-DC converter 103, and/or the buck converter, to operate under determined operation parameters. In embodiments, the controller 201 may determine one or more time parameters, such as, a design-time parameter S₁ and/or a run-time parameter S₂, and cause the converters to operate based on the one or more time parameters.

In some embodiments, the operation parameters include, without limitation, an operating range including one or more operating points (G). The operation points (G) may include an input voltage (Vᵢₙ) of the DC source, an input current (Iᵢₙ) from the DC source, an output voltage (Vₒᵤₜ) to the load, or a combination thereof. In embodiments, the input voltage may be between about 150 V and about 500 V, between about 200 V and about 450 V, between about 250 V and about 400 V, between about 300 V and about 350 V, or any value between about 0 V and about 500 V. In embodiments, the output voltage may be between about 300 V and about 950 V, between about 350 V and about 900 V, between about 400 V and about 850 V, between about 450 V and about 800 V, between about 500 V and about 750 V, between about 550 V and about 700 V, between about 500 V and about 650 V, between about 450 V and about 600 V, between about 500 V and about 550 V, or any value between about 0 V and about 1000 V. In embodiments, the input current may be between about 80 A and about 100 A, between about 85 A and about 95 A, or any value between about 80 A and about 100 A. In embodiments, an operating power of the system may be equal to or greater than about 1 kW, equal to or greater than about 10 kW, equal to or greater than about 20 kW, equal to or greater than about 50 kW, equal to or greater than about 100 kW, equal to or greater than about 200 kW, or any value equal to or greater than about 0 kW.

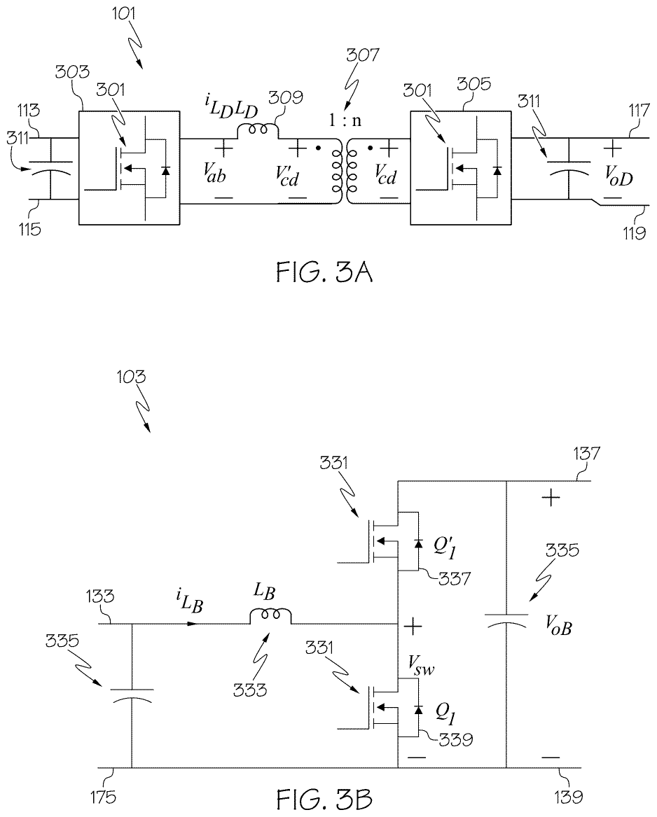

In embodiments, the converters include one or more switches, such as boost switches 331 (as in FIG. 3B) and DAB switches 301 (as in FIG. 3A). The controller 201 can control the switches to satisfy an operation of the converters based on the design-time parameter and/or the run-time parameter. For example, the controller 201 may cause the switches to switch between ON and OFF states to vary switching frequencies of the first DC-DC converter 101 and the second DC-DC converter 103 such that the composite DC-DC converter system 100 can operate to achieve a predetermined operation point G with a controlled energy loss of the composite DC-DC converter system 100.

In embodiments, the first DC-DC converter 101 is a DAB converter and the second DC-DC converter 103 is a boost converter. The DAB converter includes one or more DAB switches 301 (as in FIG. 3A). The boost converter includes one or more boost switches 331 (as in FIG. 3B). In embodiments, the boost converter module is electrically coupled to the DAB converter module in an IPOS configuration, and the controller 201 is operable to determine one or more time parameters to cause the boost converter module and the DAB converter module to operate at determined operation conditions in the operating range to control an energy loss of the composite DC-DC converter system 100. The time parameters include, without limitations, the design-time parameter S₁ and the run-time parameter S₂. In embodiments, the determined operation conditions include, without limitation, determined boost switching frequencies (F**_{sB}), determined DAB switching frequencies (F**_{sD}), a determined output voltage ratio (x*) of the first DC-DC converter 101, and the second DC-DC converter 103, a combination thereof.

In some embodiments, the second DC-DC converter 103 includes a boost positive input terminal 133, a boost negative input terminal 135, a boost positive output terminal 137, and a boost negative output terminal 139. In some embodiments, the first DC-DC converter 101 includes a DAB positive input terminal 113, a DAB negative input terminal 115, a DAB positive output terminal 117, and a DAB negative output terminal 119. In some embodiments, the converter input port 105 includes a converter positive input terminal 151 and a converter negative input terminal 153. The converter output port 107 includes a converter positive output terminal 171 and a converter negative output terminal 173. In some embodiments, the IPOS configuration includes the electrical connections between the first DC-DC converter 101 and the second DC-DC converter 103 as one or more of the following connections. For example, the converter positive input terminal 151 is electrically connected to the boost positive input terminal 133 and the DAB positive input terminal 113. The converter negative input terminal 153 is electrically connected to the boost negative input terminal 135 and the DAB negative input terminal 115. The boost positive output terminal 137 is electrically connected to the DAB negative output terminal 119. The boost negative output terminal 139 is electrically connected to the converter negative output terminal 173. The DAB positive output terminal 117 is electrically connected to the converter positive output terminal 171.

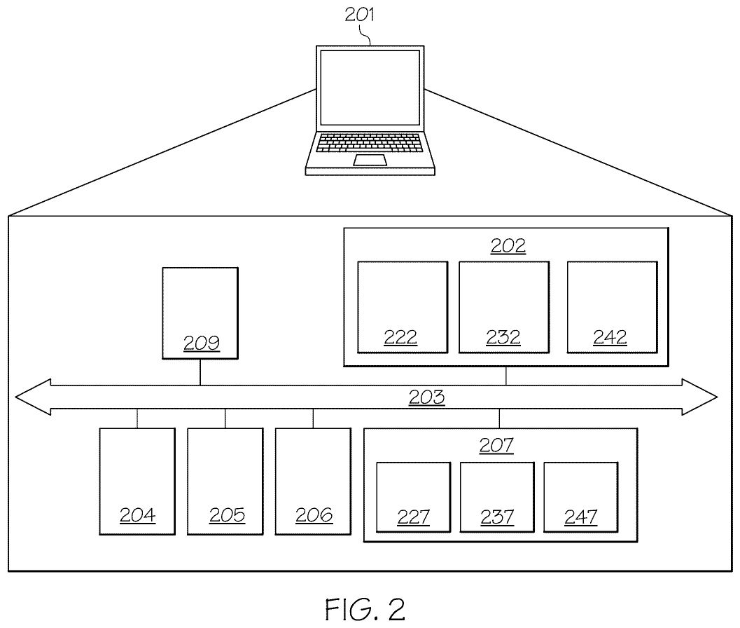

FIG. 2 is a diagram illustrating an example architecture of the controller 201. The controller 201 may include various components, such as a memory component 202, one or more processors 204, an input/output interface 205, a network interface 206, a data storage component 207, and a local interface 203. The controller 201 may include one or more modules, such as an energy loss module 222, a boost optimizer module 232, and a DAB optimizer module 242. The one or more modules may be stored in the memory component 202. The controller 201 may include a neural network 209. The data storage component 207 may store historical operating points 227, historical time parameters 237, and other operating data 247.

The controller 201 may be any device or combination of components including the processor 204 and the memory component 202. The processor 204 may be any device capable of executing a machine-readable instruction set stored in the non-transitory computer-readable memory. The processor 204 may include any processing component(s) configured to receive and execute programming instructions (such as from the data storage component 207 and/or the memory component 202). The instructions may be in the form of a machine-readable instruction set stored in the data storage component 207 and/or the memory component 202. For example, the processor 204 may include one or more chips, system-on-chips (SoCs), system-in-packages (SiPs), chipsets, packages, or devices that individually or collectively constitute or include a processing system. The processor 204 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processor 204 is communicatively coupled to the other components of the controller 201 by the local interface 203. The local interface 203 may communicatively couple any number of processors 204 with one another, and allow the components coupled to the local interface 203 to operate in a distributed computing environment. The local interface 203 may be implemented as a bus or other interface to facilitate communication among the components of the controller 201. While the embodiment depicted in FIG. 2 includes a single processor, other embodiments may include more than one processor.

The memory component 202 includes a non-transitory computer-readable memory. The memory component 202 may include RAM, ROM, a flash memory, a hard drive, other discrete gate or transistor logic or circuitry, or any non-transitory memory device capable of storing machine-readable instructions such that the machine-readable instructions can be accessed and executed by the processor 204. The machine-readable instruction set may include logic or algorithm(s) written in any programming language of any generation (e.g., 1 GL, 2 GL, 3 GL, 4 GL, or 5 GL) such as, for example, machine language that may be directly executed by the processor 204, or assembly language, object-oriented programming (OOP), scripting languages, microcode, etc., that may be compiled or assembled into machine readable instructions and stored in the memory component 202. Alternatively, the machine-readable instruction set may be written in a hardware description language (HDL), such as logic implemented via either a FPGA configuration or an ASIC, or their equivalents. Accordingly, the functionality described herein may be implemented in any conventional computer programming language, as pre-programmed hardware elements, or as a combination of hardware and software components. For example, the memory component 202 may be a machine-readable memory (which may also be referred to as a non-transitory processor-readable memory or medium) that stores instructions that, when executed by the processor 204, causes the processor 204 to perform a method or control scheme as described herein. While the embodiment depicted in FIG. 2 includes a single non-transitory computer-readable memory component, other embodiments may include more than one memory module. The memory component 202 may be used to store the one or more modules. The one or more modules during operating may be in the form of operating systems, application program modules, or other program modules. Such program modules may include, but are not limited to, routines, subroutines, programs, objects, components, and data structures for performing specific tasks or executing specific abstract data types according to the present disclosure as will be described below.

The composite DC-DC converter system 100 may be or include an artificial intelligence system such that the composite DC-DC converter system 100 may make inferences and operate based on the collected information and data related to the DC-DC conversion described herein. Particularly, the composite DC-DC converter system 100 may have machine learning functions. The various modules may include one or more machine learning models. A machine learning model may include, for example, a neural network 209 or another form of machine learning model trained using a machine learning algorithm. The various modules may be trained and provided with machine learning capabilities via the neural network 209 as described herein. It should be noted that reference to “a/the neural network 209” can include a plurality of neural networks configured to control various functions or perform inferences based on various data. For example, a first neural network 209 may process operating points to identify converters in the composite DC-DC converter system 100 and determine the operating parameters to satisfy the operating points, and a second neural network 209 may determine whether the operating parameters satisfy the energy loss requirement.

The architecture of the neural network 209 may include, without limitation, a deep learning architecture or another form of architecture. The deep learning architecture may be, without limitation, a transformer based with self-attention, a feed-forward neural network, a recurrent neural network (RNN) architecture, a large language model (LLM), a natural language processing (NLP) model, a convolutional neural network (CNN), a generative model (e.g., a diffusion model), a vision transformer, or a multi-layer perceptron mixer. By way of example, and not as a limitation, the neural network 209 may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. Further, each of the various modules may include one or more generative artificial intelligence algorithms. The generative artificial intelligence algorithm may include a general adversarial network (GAN) that has two networks, such as a generator model and a discriminator model. The generative artificial intelligence algorithm may also be based on variation autoencoder (VAE) or transformer-based models.

The input/output interface 205 may include a monitor, keyboard, mouse, printer, camera, microphone, speaker, joystick, control panel, and/or other device for receiving, sending, and/or presenting data. The network interface 206 may include any wired or wireless networking hardware, such as a modem, LAN port, Wi-Fi card, WiMax card, mobile communications hardware, and/or other hardware for communicating with other networks and/or devices. The data storage component 207 may store the one or more modules, data collected in the course of operation of the composite DC-DC converter system 100, configuration information for the composite DC-DC converter system 100, or other data relevant to aspects described herein. The input/output interface 205 and/or the network interface 206 allow a user to send input to the controller 201 of the composite DC-DC converter system 100 to control and manipulate the components of the composite DC-DC converter system 100, and receive output from the controller 201.

The controller 201 may be a local controller that is included in the composite DC-DC converters, or may be a remote controller that operates remotely from the composite DC-DC converters. One or more connections connect components of the composite DC-DC converter system 100 to the controller 201 and allow signal transmission between the components of the composite DC-DC converter system 100. A connection may be a wired connection, a wireless connection, or a combination thereof. The one or more connections may be formed from any medium that is capable of transmitting a signal such as, for example, conductive wires, conductive traces, optical waveguides, or the like. In some embodiments, the one or more connections may facilitate the transmission of wireless signals, such as according to a communication protocol (e.g., WiFi, Bluetooth®, Near Field Communication (NFC), or the like). Moreover, the one or more connections may be formed from a combination of media capable of transmitting signals. In some embodiments, the one or more connections may include a combination of conductive traces, conductive wires, connectors, and/or buses that cooperate to permit the transmission of electrical data signals to components such as processors, memories, sensors, input devices, output devices, and/or communication devices. Accordingly, the one or more connections may include a vehicle bus, such as for example a Local Interconnect Network (LIN) bus, a Controller Area Network (CAN) bus, a Vehicle Area Network (VAN) bus, and the like. Additionally, it is noted that the term “signal” means a waveform (e.g., electrical, optical, magnetic, mechanical, or electromagnetic), such as direct current, alternating current, sinusoidal-wave, triangular-wave, square-wave, vibration, and the like, capable of traveling through a medium. In some embodiments, the controller 201 may communicate with the components of the composite DC-DC converter system 100 through wireless communication technologies, such as, without limitation, radio frequency (RF) communication, Bluetooth (a short-range wireless communication technology), Wi-Fi (a local wireless network based on IEEE 802.11 standards), Zigbee (a low-power, short-range wireless technology based on IEEE 802.15.4 standards), Z-Wave (a mesh network using low energy radio waves), a cellular radio access technology (such as 2G, 3G, 4G, 5G, or 6G), a sidelink technology, satellite communication, or Narrowband Internet of Things (NB-IoT, a low-power wide-area network radio technology).

FIGS. 3A and 3B illustrate an example first DC-DC converter (FIG. 3A) and an example second DC-DC converter (FIG. 3B). In embodiments, as illustrated in FIG. 3A, the first DC-DC converter 101 is a DAB converter module. In embodiments, the DAB converter module includes, without limitation, a primary DAB bridge 303, a secondary DAB bridge 305, a transformer 307, a DAB inductor 309, and/or one or more capacitors 311. The primary DAB bridge 303 may include one or more DAB switches 301 (e.g., four or more), which may be metal-oxide-semiconductor field-effect transistor (MOSFET)-based switches and/or insulated-gate bipolar transistor (IGBT)-based switches, arranged in a bridge configuration, such as a H-bridge or full bridge configuration. The primary DAB bridge 303 may modulate the input power from the DC source to convert the input electricity into a high-frequency AC signal that can be transmitted through the transformer 307 to the secondary DAB bridge 305. The secondary DAB bridge 305 may include one or more DAB switches 301 (e.g., four or more), which may be MOSFET-based switches and/or IGBT-based switches arranged in a full-bridge configuration. The secondary DAB bridge can manage the power flow from the transformer 307 to the load. In embodiments, the primary DAB bridge 303 is electrically connected to the secondary DAB bridge 305 via the transformer 307 and/or the DAB inductor 309.

In embodiments, as illustrated in FIG. 3B, the second DC-DC converter 103 is a boost converter module. In embodiments, the boost converter module includes, without limitation, a boost inductor 333, one or more boost capacitors 335, a primary boost switch 339, and a synchronous boost switch 337. The primary boost switch 339 and the synchronous boost switch 337 may be MOSFET-based switches and/or IGBT-based switches. In embodiments, the boost inductor 333 connects to the boost positive input terminal 133 to store energy when the primary boost switch 339 is on. The primary boost switch 339 connects the boost inductor 333 to the boost negative output terminal 139. The synchronous boost switch 337 connects the boost inductor 333 to the boost positive output terminal 137. In embodiments, the synchronous boost switch 337 is on and/or conducts when the primary boost switch 339 is off, providing a path for the boost inductor's stored energy to transfer to the boost capacitor 335 paralleled to the boost positive output terminal 137 and the boost negative output terminal 139, and the load.

In embodiments, the design-time parameter S₁ is determined based on, without limitation, an inductance of the DAB inductor (L_{D}), an inductance of the boost inductor (L_{B}), a transformation ratio of the transformer (n), or a combination thereof. For example, the design-time parameter S₁ can be denoted as S₁≙(n, L_{D}, L_{B}). In embodiments, the run-time parameter S₂ is determined based on, without limitation, boost switching frequencies (F_{sB}), DAB switching frequencies (F_{sD}), an output voltage ratio (x) of the second DC-DC converter 103 and the first DC-DC converter 101, or a combination thereof. For example, the run-time parameter S₂ can be denoted as S₂≙(x, F_{sD}, F_{sB}). The design-time parameter S₁ and/or the run-time parameter S₂ can be used to minimize the worst-case device loss over the entire operating range. The output voltage ratio (x) is the ratio of the second DC-DC converter 103 output voltage (V_{oB}) and the composite DC-DC converter output voltage (Vₒ). Thus, the output voltage ratio can be denoted as x≙V_{oB}/Vₒ and it follows that the first converter output (V_{oD})=(1−x)Vₒ. In embodiments, the IPOS configuration of the modules provides a boost input current (IinB), and the system input current Iᵢₙ follows that I_{inB}=XIᵢₙ. The DAB input current (I_{inD}) and the system input current follow that I_{inD}=(1−x)Iᵢₙ. The controller 201 may include the energy loss module 222 to determine a desired set of design parameters, S₁*≙(n*, L_{sD}*, L_{sB}*), which may be constant for the entire operating range. The energy loss module 222 can determine the determined run-time parameter S₂*≙(x*, F_{sD}**, F_{sB}**), which may vary from one operating point (G) to another by the action of the composite DC-DC converter system 100. In some embodiments, V_{oD} and V_{oB} may be controlled to be less than or equal to 500 V. In some embodiments, the operating parameters may include 100 kHz≤F_{sD}, F_{sB}≤200 kHz, 1≤n≤2, 0.5 μH≤L_{D}≤10 μH, and 1 μH≤L_{B}≤20 μH.

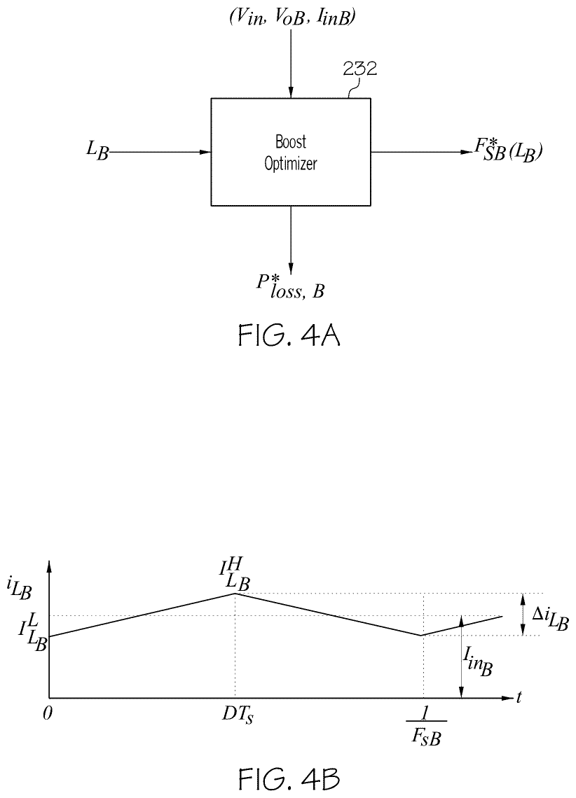

Turning to FIGS. 4A and 4B, FIG. 4A illustrates a block diagram for determining energy loss for the second DC-DC converter 103. FIG. 4B depicts a current waveform of the second DC-DC converter 103. As illustrated in FIG. 4B, a boost inductor current (i_{LB}) (as in FIG. 3B) includes a peak-to-peak ripple (Δi_{LB}) and a duty ratio (D) of the primary boost switch 339. The second converter may include a boost conduction loss (P_{end,B}) and a boost switching loss (P_{sw},B). In embodiments, the boost conduction loss can be calculated by Equation 1 below.

$${P}_{c n d , B} = {P}_{d s o n} ( {I}_{i n B}^{2} + \frac{Δ {i}_{IB}^{2}}{12} ) \qquad Eq . 1$$

The boost switching loss can be calculated by Equation 2 below

$${P}_{sw , B} = \{ \begin{matrix}{E}_{O N} ( {V}_{o B} , {I}_{LB}^{L} ) + {E}_{O F F} ( {V}_{o B} , {I}_{LB}^{H} ) {F}_{s B} , {I}_{LB}^{L} > 0 \\ {E}_{O F F} ( {V}_{o B} , {I}_{LB}^{L} ) + {E}_{O F F} ( {V}_{o B} , {I}_{LB}^{H} ) {F}_{s B} , {I}_{LB}^{L} < 0\end{matrix} \qquad Eq . 2$$

wherein R_{dson} is switch on-state resistance, P_{sw,B} depends upon the switching instant currents, L^{L}_{LB}=I_{inB}−(Δi_{LB}/2) and I^{H}_{LB}=I_{inB}+(ΔiL_{LB}/2). E_{ON} and E_{OFF} are turn-ON and turn-OFF switching energy loss functions. The loss model accounts for the zero-voltage-switching (ZVS) operation when I^{L}_{LB}<0. In a Boost pass-through mode, D=0, and only the conduction loss is present. Since Δi_{LB}=(VᵢₙD)/(F_{sB}L_{B}), both P_{end,B} and P_{sw,B} are functions of F_{sB} and L_{B}. Given a set of operating conditions and L_{B}, the boost optimizer module 232 can determine a determined boost switching frequency F_{sB} such that P*_{loss,B} is minimized.

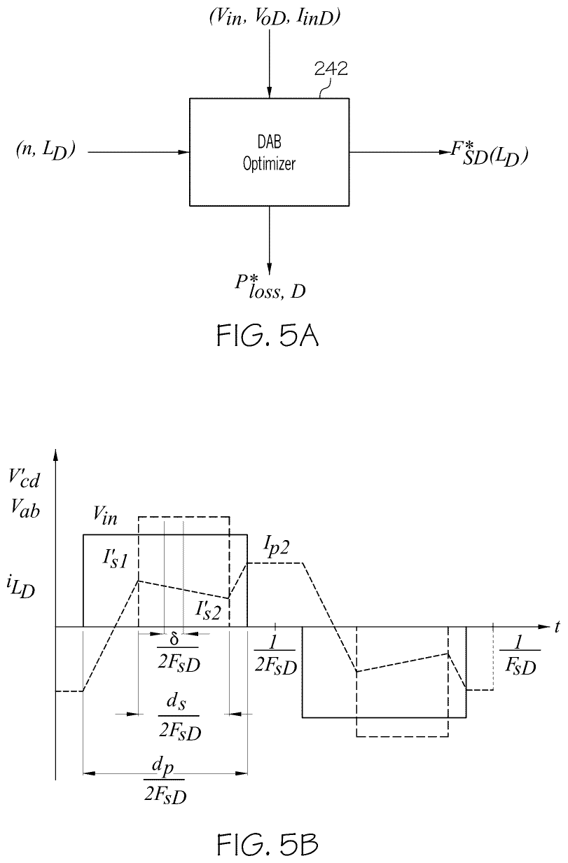

Turning to FIGS. 5A and 5B. FIG. 5A illustrates a block diagram for determining energy loss for the first DC-DC converter 101. FIG. 5B depicts a current waveform of the first DC-DC converter 101. In embodiments, the composite DC-DC converter system 100 is configured to minimize a triple-phase-shift (TPS) of an inductor root mean square (RMS) current for the first DC-DC converter 101. FIG. 5B illustrates the TPS parameters, dₚ, dₛ, and δ, and illustrative voltage and inductor current waveforms. A DAB conduction loss (P_{end},D) of the first DC-DC converter 101 can be calculated in Equation 3 below

$${P}_{c n d , D} = 2 {R}_{d s o n} ( {I}_{p , RMS}^{2} + {I}_{s , RMS}^{2} ) \qquad Eq . 3$$

A DAB switching loss (P_{sw,D}) of the first DC-DC converter 101 can be calculated in Equation 4 below

$${P}_{sw , D} = 2 ( \begin{matrix}{E}_{O F F} ( {V}_{i n} , \vert {I}_{p 1} \vert ) + {E}_{O F F} ( {V}_{i n} , \vert {I}_{p 2} \vert ) \\ {E}_{O F F} ( {V}_{oD} , \vert {I}_{s 1} \vert ) + {E}_{O F F} ( {V}_{oD} , \vert {I}_{s 2} \vert )\end{matrix} ) {F}_{s D} \qquad Eq . 4$$

wherein I_{p,RMS} and I_{s,RMS} are the primary and secondary bridge RMS currents. The switching instant current pairs over a half cycle of primary and secondary bridges are (Iₚ₁, Iₚ₂) and (Iₛ₁, Iₛ₂), respectively. A total first DC-DC converter energy loss (P_{loss,D}) is a combination of the DAB conduction loss (P_{end,D}) and the DAB switching loss (P_{sw,D}). The total first DC-DC converter energy loss may depend upon the design-time parameters, n, and L_{D}. The DAB optimizer module 242 can determine the determined DAB switching frequencies FasD based on the input voltage Vᵢₙ, the first converter output (V_{oD}), the first converter input current (I_{inD}), with the corresponding design-time parameters, n and L_{D} such that P_{loss,D} is minimized.

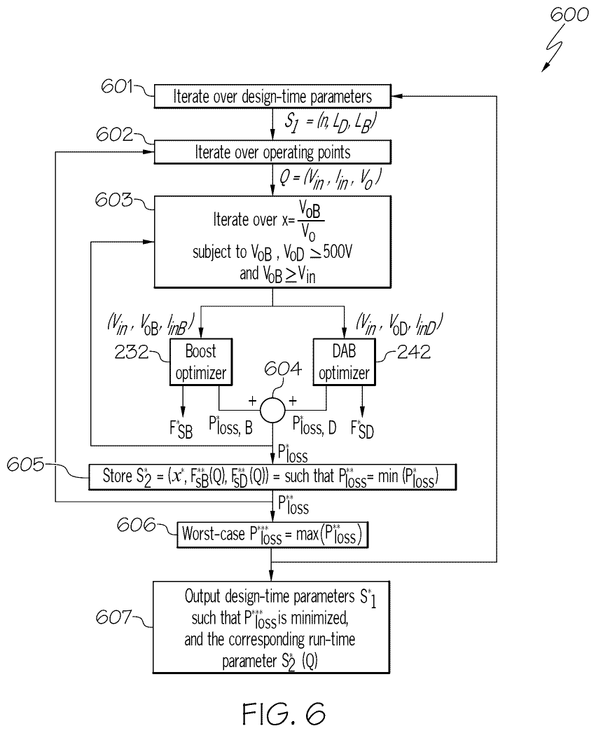

FIG. 6 depicts a flowchart for an illustrative block diagram for a method 600 to determine design-time parameter S₁*≙(n*, L_{sD}*, L_{sB}*), and run-time parameter S₂*≙(x*, F_{sD}**, F_{sB}**),) for energy loss control of the disclosed composite DC-DC converters and further to control the energy loss of the system to include a worst-case device loss over the full operating range is minimized.

At block 601, the method 600 may include iterating over design-time parameter S₁ to determine a set of S₁ including a set of (n, L_{sD}, L_{sB}). At block 602, the method 600 may include iterating over operating points Q to determine a set of (Vᵢₙ, Iᵢₙ, Vₒ) within the operating range for the composite DC-DC converters operation.

At block 603, the method 600 may include determining operating restrictions and further iterating output voltage ratio (x=V_{oB}/Vₒ) based on the operating restrictions. The operation restrictions may include maximum operating voltages of the first DC-DC converter 101 (V_{oB}) and the second DC-DC converter 103 (Vo_{D}), for example, less than or equal to 500V, and relative relationship of V_{oB}, V_{oD}, and/or Vᵢₙ, for example, V_{oB} greater than and equal to Vᵢₙ. The method 600 may further include performing boost optimization using the boost optimizer module 232 for the second DC-DC converter 103 and performing DAB optimization using the DAB optimizer module 242 for the first DC-DC converter 101, similar to FIGS. 4A and 5A, respectfully. The boost optimizer module 232 may generate determined boost switching frequencies F*_{sB} for each operating point Q along with determined boost energy losses P_{loss, B} for each operating point Q. The DAB optimizer module 242 may generate determined DAB switching frequencies F*_{sD} for each operating point Q along with determined DAB energy losses P*_{loss, D} for each operating point Q.

At block 604, the method 600 may include consolidating the generated boost energy losses P*_{loss, B} and determined DAB energy losses P*_{loss, D} to generate total energy losses P*ₗₒₛₛ for each possible F_{sB} and/or F_{sD} at a given Q. The generated P*ₗₒₛₛ may be fed back to repeat the process from block 603 to block 604.

At block 605, the method 600 may include determining the determined run-time parameters S*₂ including (x*, F**_{sB}, F**_{sD}) for each possible F_{sB} and/or F_{sD} at a given Q to determine the minimum total energy loss (P**ₗₒₛₛ) that is the lowest P*ₗₒₛₛ among all the possible operating points Q. The process from block 602 to block 605 may repeat until all operating points Q have been covered. At block 606, the method 600 may include determine a worst-case energy loss P***ₗₒₛₛ, which is the maximum of the minimum energy loss losses (P**ₗₒₛₛ) among all operating points Q. The process may return to block 601 to repeat from block 601 to block 606 to generate all possible worst-case energy losses P***ₗₒₛₛ for all design-time parameters.

At block 607, the method 600 may include outputting determined design-time parameter S*₁ and determined run-time parameter S*₂ for the minimized worst-case energy losses P***ₗₒₛₛ. Accordingly, a user can select various converter components at predetermined electrical properties, such as n, L_{D}, L_{B} based on S*1, and determine predetermined operating parameters, such as switching frequencies, for the converters, such as the first DC-DC converter 101 and the second DC-DC converter 103, for controlled energy loss.

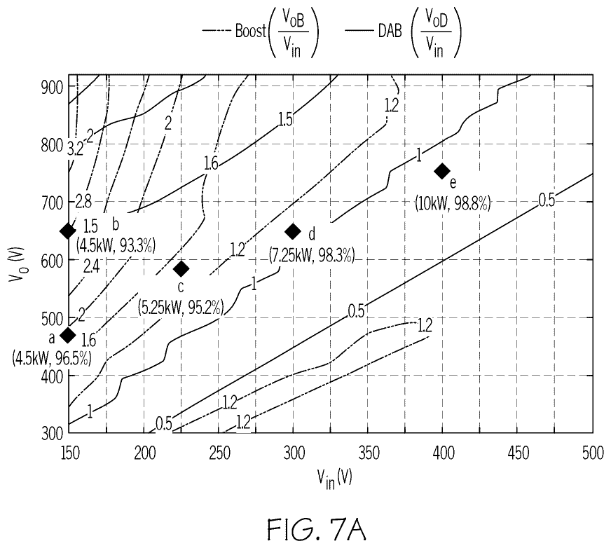

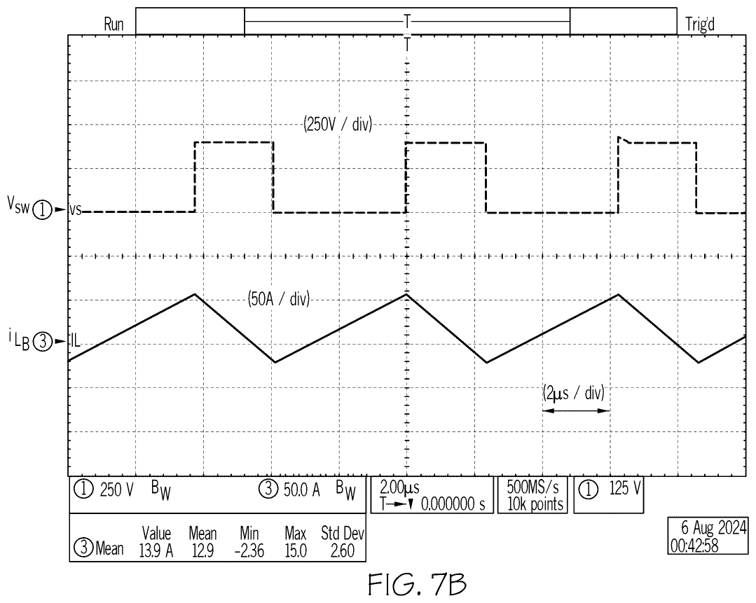

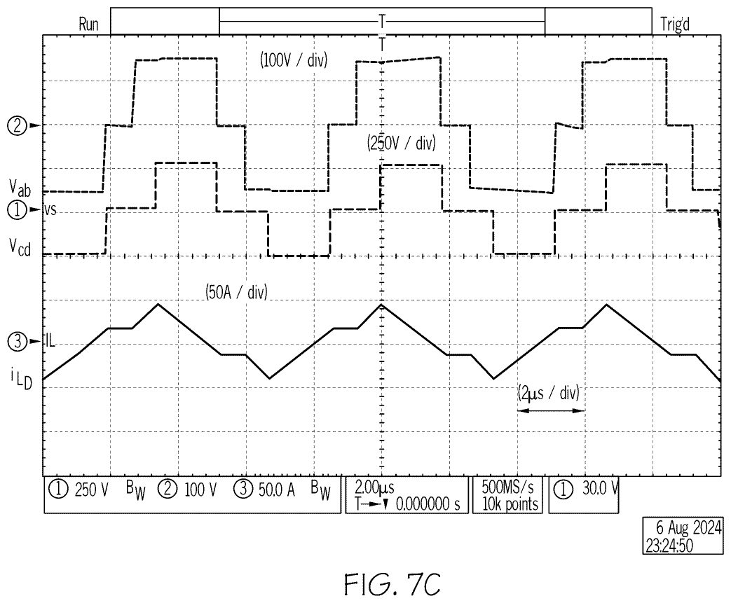

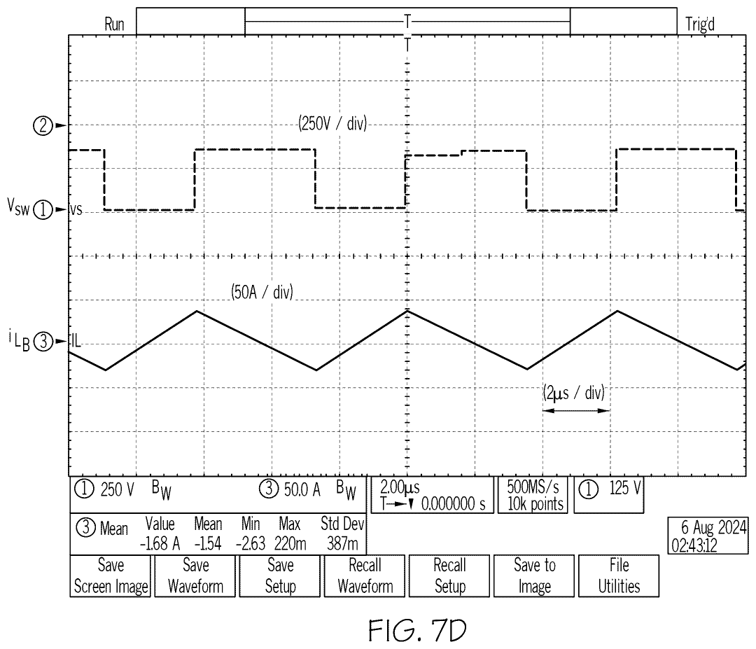

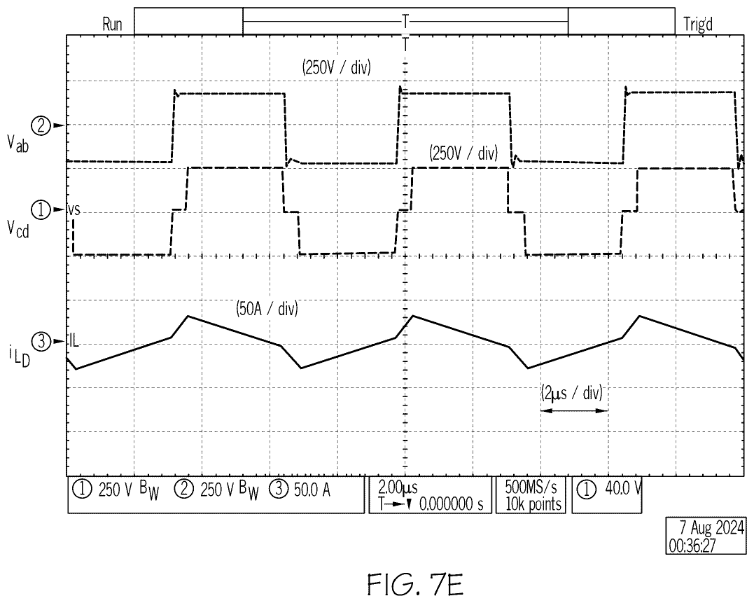

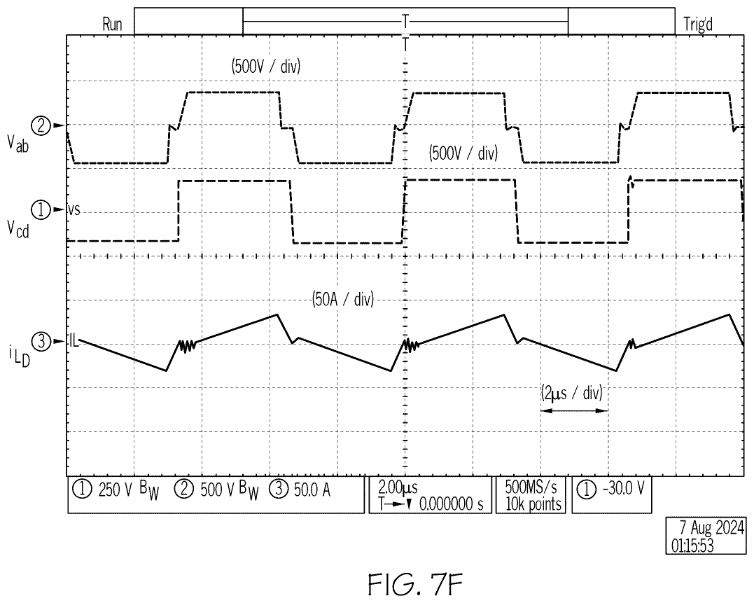

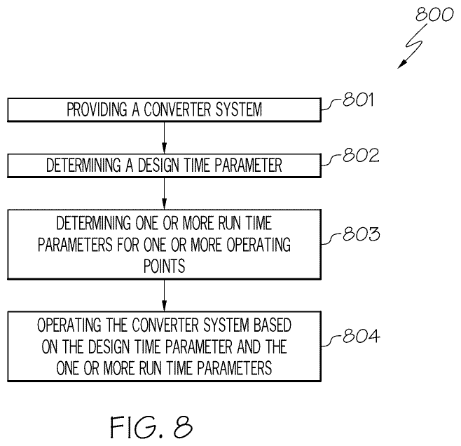

Turning to FIGS. 7A-7F, example optimal voltages sharing between the first DC-DC converter and the second DC-DC converter of the present disclosure are depicted. The controlled design is used to construct a 40 kW configuration. Planar inductors and transformer have n=1, L_{D}=3.7 μH, and L_{B}=7.5 μH, close to the determined optimal values based on the method 600 described above. FIG. 7A marks the power ratings and measured efficiency at several operating points, while FIGS. 7B-7F show the experimental waveforms at points b, c, and e in FIG. 7A. FIGS. 7B-7F shows how the first DC-DC converter 101 can work with TPS modulation at points b (Vᵢₙ=150 V, V_{oB}=400 V, V_{oD}=250 V, P_{B}=2.4 KW, P_{D}=2.1 kW), c (Vᵢₙ=200 V, V_{oB}=350 V, V_{oD}=240 V, P_{B}=3 KW, P_{D}=2.25 KW), and e (Vᵢₙ=400 V, V_{oD}=350 V, P_{D}=4.5 kW) as in FIG. 71A. At point e (Vᵢₙ=400 V, V_{oD}=350 V, P_{D}=4.5 KW), the second DC-DC converter 103 is in pass-through mode with D=0, which results in 98.8% efficiency at 10 kW. Through the modeling, a minimized worst-case energy loss over a wide range of input (150-500 V) and output (300-920 V) voltages is determined to have an energy efficiency 98.8% at 10 kW.

FIG. 8 depicts a flowchart of a method 800 for operating an example composite DC-DC converter system of the present disclosure, according to one or more embodiments shown and described herein. At block 801, the method 800 includes providing the composite DC-DC converter system 100. The composite DC-DC converter system 100 (as in FIG. 1) includes a boost converter module including one or more boost switches 331 (as in FIG. 3B) and a boost inductor 333 (as in FIG. 3B), and a dual-active bridge (DAB) converter module including one or more DAB switches 301 (as in FIG. 3A), a DAB inductor 309 (as in FIG. 3A), and a transformer 307 (as in FIG. 3A), the DAB converter module configured to electrically coupled to the boost converter module in an input parallel and output series (IPOS) configuration.

At block 802, the method 800 includes determining a design-time parameter based on an inductance of the DAB inductor 309, an inductance of the boost inductor 333, a transformation ratio of the transformer 307, or a combination thereof. At block 803, the method 800 includes determining one or more run-time parameters for one or more operating points in an operating range such that a converter system energy loss at any operation point is less than or equal to a worst-case energy loss. At block 804, the method 800 includes operating the composite DC-DC converter system 100 based on the design-time parameter and the one or more run-time parameters.

In some embodiments, the one or more run-time parameters include determined DAB switching frequencies of the DAB converter module, determined boost switching frequencies of the boost converter module, DAB output voltage, boost output voltage, or a combination thereof.

In some embodiments, the determining one or more run-time parameters at block 803 may further include calculating a determined boost switching frequency based on an input voltage of the composite DC-DC converter system 100, the boost output voltage, a boost switching current, or a combination thereof, such that an energy loss of the boost converter module is minimized. In some embodiments, the determining one or more run-time parameters at block 803 may further include calculating a determined DAB switching frequency based on an input voltage of the converter system, the DAB output voltage, a DAB switching current, or a combination thereof, such that an energy loss of the DAB converter module is minimized.

In some embodiments, the operating the converter system at block 804 may further include operating the boost converter module at determined boost switching frequencies and a determined boost output voltage, and operating the DAB converter module at determined DAB switching frequencies and a determined DAB output voltage.

In some embodiments, the boost converter module may further include a boost positive input terminal 133 (as in FIG. 1), a boost negative input terminal 135 (as in FIG. 1), a boost positive output terminal 137 (as in FIG. 1), and a boost negative output terminal 139 (as in FIG. 1). The DAB converter module may further include a DAB positive input terminal 113 (as in FIG. 1), a DAB negative input terminal 115 (as in FIG. 1), a DAB positive output terminal 117 (as in FIG. 1), and a DAB negative output terminal 119 (as in FIG. 1). The IPOS configuration may include an electrical connection between the boost positive input terminal 133 and the DAB positive input terminal 113, an electrical connection between the boost negative input terminal 135 and the DAB negative input terminal 115, an electrical connection between the boost positive output terminal 137 and the DAB negative output terminal 119, or a combination thereof.

In some embodiments, the DAB converter module may include a primary DAB bridge 303 (as in FIG. 3A), a secondary DAB bridge 305 (as in FIG. 3A), the transformer 307, and the DAB inductor 309. The primary DAB bridge 303 may be electrically connected to the secondary DAB bridge 305 via the transformer 307 and/or the DAB inductor 309. The primary DAB bridge 303 and the secondary DAB bridge 305 may include the one or more DAB switches 301.

In some embodiments, the boost converter module may include the boost inductor 333, a boost capacitor 335, and the one or more boost switches 331 including a primary boost switch 339 (as in FIG. 3B) and a synchronous boost switch 337 (as in FIG. 3B).

In some embodiments, each operating point includes an input voltage of the converter system, an input current of the converter system, an output voltage of the converter system, or a combination thereof.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A converter system comprising:
a converter input port;
a converter output port;
a boost converter module comprising one or more boost switches;
a dual-active bridge (DAB) converter module comprising one or more DAB switches; and
one or more processors;
wherein:
the boost converter module is electrically coupled to the DAB converter module in an input parallel and output series (IPOS) configuration, and
the one or more processors operable to determine one or more time parameters to cause the boost converter module and the DAB converter module to operate at determined operation conditions in an operating range to control an energy loss.

2. The system of claim 1, wherein the determined operation conditions comprise:
determined boost switching frequencies;
determined DAB switching frequencies;
a determined output voltage ratio of the boost converter module and the DAB converter module; or
a combination thereof.

3. The system of claim 1, wherein:
the boost converter module comprises a boost positive input terminal, a boost negative input terminal, a boost positive output terminal, and a boost negative output terminal;
the DAB converter module comprises a DAB positive input terminal, a DAB negative input terminal, a DAB positive output terminal, and a DAB negative output terminal;
the converter input port comprises a converter positive input terminal and a converter negative input terminal; and
the converter output port comprises a converter positive output terminal and a converter negative output terminal.

4. The system of claim 3, wherein the IPOS configuration comprises:
the converter positive input terminal electrically connected to the boost positive input terminal and the DAB positive input terminal; and
the converter negative input terminal electrically connected to the boost negative input terminal and the DAB negative input terminal.

5. The system of claim 3, wherein the IPOS configuration comprises:
the boost positive output terminal electrically connected to the DAB negative output terminal;
the boost negative output terminal electrically connected to the converter negative output terminal; and
the DAB positive output terminal electrically connected to the converter positive output terminal.

6. The system of claim 1, wherein the DAB converter module comprises:
a primary DAB bridge;
a secondary DAB bridge;
a transformer;
a DAB inductor; and
wherein:
the primary DAB bridge is electrically connected to the secondary DAB bridge via the transformer and the DAB inductor, and
the primary DAB bridge and the secondary DAB bridge comprise the one or more DAB switches.

7. The system of claim 1, wherein the boost converter module comprises:
a boost inductor;
a boost capacitor; and
the one or more boost switches comprising a primary boost switch and a synchronous boost switch.

8. The system of claim 1, wherein the one or more time parameters comprise a design-time parameter, a determined run-time parameter, or both.

9. The system of claim 8, wherein:
the DAB converter module comprises a DAB inductor and a transformer;
the boost converter module comprises a boost inductor; and
the design-time parameter is determined based on an inductance of the DAB inductor, an inductance of the boost inductor, a transformation ratio of the transformer, or a combination thereof.

10. The system of claim 8, wherein the determined run-time parameter comprises determined DAB switching frequencies of the DAB converter module, determined boost switching frequencies of the boost converter module, DAB output voltage, boost output voltage, or a combination thereof.

11. The system of claim 1, wherein the operating range includes one or more operation points, each operating point comprising an input voltage of the system, an input current of the system, an output voltage of the system, or a combination thereof.

12. A method for controlling energy loss of a converter system comprising:
providing the converter system comprising:
a boost converter module comprising one or more boost switches and a boost inductor; and
a dual-active bridge (DAB) converter module comprising one or more DAB switches, a DAB inductor, and a transformer, the DAB converter module configured to electrically coupled to the boost converter module in an input parallel and output series (IPOS) configuration;
determining a design-time parameter based on an inductance of the DAB inductor, an inductance of the boost inductor, a transformation ratio of the transformer, or a combination thereof;
determining one or more run-time parameters for one or more operating points in an operating range such that a converter system energy loss at any operation point is less than or equal to a worst-case energy loss; and
operating the converter system based on the design-time parameter and the one or more run-time parameters.

13. The method of claim 12, wherein the one or more run-time parameters comprise determined DAB switching frequencies of the DAB converter module, determined boost switching frequencies of the boost converter module, DAB output voltage, boost output voltage, or a combination thereof.

14. The method of claim 13, wherein the determining one or more run-time parameters further comprises:
calculating a determined boost switching frequency based on an input voltage of the converter system, the boost output voltage, a boost switching current, or a combination thereof, such that an energy loss of the boost converter module is minimized.

15. The method of claim 13, wherein the determining one or more run-time parameters further comprises:
calculating a determined DAB switching frequency based on an input voltage of the converter system, the DAB output voltage, a DAB switching current, or a combination thereof, such that an energy loss of the DAB converter module is minimized.

16. The method of claim 12, wherein the operating the converter system further comprises:
operating the boost converter module at determined boost switching frequencies and a determined boost output voltage; and
operating the DAB converter module at determined DAB switching frequencies and a determined DAB output voltage.

17. The method of claim 12, wherein:
the boost converter module further comprises a boost positive input terminal, a boost negative input terminal, a boost positive output terminal, and a boost negative output terminal;
the DAB converter module further comprises a DAB positive input terminal, a DAB negative input terminal, a DAB positive output terminal, and a DAB negative output terminal; and
the IPOS configuration comprises:
an electrical connection between the boost positive input terminal and the DAB positive input terminal;
an electrical connection between the boost negative input terminal and the DAB negative input terminal; and
an electrical connection between the boost positive output terminal and the DAB negative output terminal.

18. The method of claim 12, wherein the DAB converter module comprises:
a primary DAB bridge;
a secondary DAB bridge;
the transformer;
the DAB inductor; and
wherein:
the primary DAB bridge is electrically connected to the secondary DAB bridge via the transformer and the DAB inductor, and
the primary DAB bridge and the secondary DAB bridge comprise the one or more DAB switches.

19. The method of claim 12, wherein the boost converter module comprises:
the boost inductor;
a boost capacitor; and
the one or more boost switches comprising a primary boost switch and a synchronous boost switch.

20. The method of claim 12, wherein each operating point comprises an input voltage of the converter system, an input current of the converter system, an output voltage of the converter system, or a combination thereof.
